(19) United States
(12) Patent Application Publication
(10) Pub. No.: US 2023/0310999 A1
(43) Pub. Date: Oct. 5, 2023

(54) In-game Physics with Affine Bodies

(71) Applicant: Electronic Arts Inc., Redwood City, CA (US)

(72) Inventor: Christopher Charles Lewin, London (GB)

(21) Appl. No.: 17/710,355

(22) Filed: Mar. 31, 2022

(51) Int. Cl. A63F 13/577; G06T 3/00; G06T 11/00

(52) U.S. Cl. CPC A63F 13/577; A63F 2300/643; G06T 11/001; G06T 3/0006

(57) ABSTRACT

This specification relates to in-game physics simulations, and in particular to the simulation of in-game objects as affine bodies. According to a first aspect of this disclosure, there is described a computer implemented method comprising: representing a first in-game object in a plurality of in-game objects using an affine body representation, wherein the affine body representation comprises a translation vector and a deformation matrix; and updating an in-game physics state of the plurality of in-game objects, the in game physics state comprising a current translation vector and a current deformation matrix of the first in-game object. The updating comprises: determining one or more constraints to the plurality of in-game objects; determining one or more relaxed constraints by relaxing the one or more constraints based on a stiffness of the first in-game object; and determining an updated in-game physics state of the first in-game object, comprising solving the one or more relaxed constraints and equations of motion for the plurality of in-game objects.

### FIELD

This specification relates to in-game physics simulations, and in particular to the simulation of in-game objects as affine bodies.

### BACKGROUND

In games and other real-time simulations, the primary representation of the physical world of the game is one of rigid body dynamics (RBD). In this system, all objects in the game are simulated as rigid bodies—bodies that cannot be stretched, deformed, broken or bent. A good example of a near-rigid body in the real world is something like a heavy block of steel. Traditional methods of representing soft-body dynamics, such as the Finite Element Method (FEM) or Material Point Method (MPM) are several orders of magnitude more expensive than rigid body simulation, and so cannot be used widely in real-time applications.

Consequently, non-rigid deformations (such as squash and stretch) are typically represented in games as additional graphical effects that are not accounted for in the physics world. This is an additional effort implemented as a purely graphical ‘smoke and mirrors’ effect rather than something that can have gameplay consequences.

### SUMMARY

According to a first aspect of this disclosure, there is described a computer implemented method comprising: representing a first in-game object in a plurality of in-game objects using an affine body representation, wherein the affine body representation comprises a translation vector and a deformation matrix; and updating an in-game physics state of the plurality of in-game objects, the in game physics state comprising a current translation vector and a current deformation matrix of the first in-game object. The updating comprises: determining one or more constraints to the plurality of in-game objects; determining one or more relaxed constraints by relaxing the one or more constraints based on a stiffness of the first in-game object; and determining an updated in-game physics state of the first in-game object, comprising solving the one or more relaxed constraints and equations of motion for the plurality of in-game objects.

Updating an in-game physics state of the plurality of in-game objects may comprise simulating a collision between the first object and a second object in the plurality of in-game objects. The one or more constraints may comprise one or more collision constraints. The a second object in the plurality of in-game objects may comprise an in-game object represented as a rigid body. Alternatively, the second object in the plurality of in-game objects may comprise an in-game object represented as an affine body.

The method may further comprise: determining whether a current deformation matrix of the first in-game object represents a deformation above a threshold deformation; and in response to a positive determination, replacing a current in-game graphical texture of the first in-game object with deformed texture.

The method may further comprise: determining whether a current deformation matrix of the first in-game object represents a deformation above a threshold deformation; and in response to a positive determination, replacing the affine representation of the object with a higher order representation.

The one or more constraints may further comprise one or more of: an minimum size of the first in-game object; a maximum size of the first in-game object; and/or a fixed volume of the first in-game object.

According to a further aspect of this disclosure, there is described a non-transitory computer readable medium comprising computer readable instructions that, when executed by a computer, cause the computer to perform a method comprising: representing a first in-game object in a plurality of in-game objects using an affine body representation, wherein the affine body representation comprises a translation vector and a deformation matrix; and updating an in-game physics state of the plurality of in-game objects, the in game physics state comprising a current translation vector and a current deformation matrix of the first in-game object. The updating comprises: determining one or more constraints to the plurality of in-game objects; determining one or more relaxed constraints by relaxing the one or more constraints based on a stiffness of the first in-game object; and determining an updated in-game physics state of the first in-game object, comprising solving the one or more relaxed constraints and equations of motion for the plurality of in-game objects.

Updating an in-game physics state of the plurality of in-game objects may comprise simulating a collision between the first object and a second object in the plurality of in-game objects, and wherein the one or more constraints comprises one or more collision constraints. The a second object in the plurality of in-game objects may comprise an in-game object represented as a rigid body. Alternatively, the second object in the plurality of in-game objects may comprise an in-game object represented as an affine body.

The method may further comprise: determining whether a current deformation matrix of the first in-game object represents a deformation above a threshold deformation; and in response to a positive determination, replacing a current in-game graphical texture of the first in-game object with deformed texture.

The method further may comprise: determining whether a current deformation matrix of the first in-game object represents a deformation above a threshold deformation; and in response to a positive determination, replacing the affine representation of the object with a higher order representation.

The one or more constraints may further comprise one or more of: an minimum size of the first in-game object; a maximum size of the first in-game object; and/or a fixed volume of the first in-game object.

According to a further aspect of this specification, there is described a system comprising one or more processors and a memory, the memory storing computer readable instructions that, when executed by the one or more processors, causes the system to perform a method comprising: representing a first in-game object in a plurality of in-game objects using an affine body representation, wherein the affine body representation comprises a translation vector and a deformation matrix; and updating an in-game physics state of the plurality of in-game objects, the in game physics state comprising a current translation vector and a current deformation matrix of the first in-game object. The updating comprises: determining one or more constraints to the plurality of in-game objects; determining one or more relaxed constraints by relaxing the one or more constraints based on a stiffness of the first in-game object; and determining an updated in-game physics state of the first in-game object, comprising solving the one or more relaxed constraints and equations of motion for the plurality of in-game objects.

Updating an in-game physics state of the plurality of in-game objects may comprise simulating a collision between the first object and a second object in the plurality of in-game objects, and wherein the one or more constraints comprises one or more collision constraints. The a second object in the plurality of in-game objects may comprise an in-game object represented as a rigid body

The method may further comprise: determining whether a current deformation matrix of the first in-game object represents a deformation above a threshold deformation; and in response to a positive determination, replacing a current in-game graphical texture of the first in-game object with deformed texture.

The method may further comprise: determining whether a current deformation matrix of the first in-game object represents a deformation above a threshold deformation; and in response to a positive determination, replacing the affine representation of the object with a higher order representation

The one or more constraints may further comprise one or more of: an minimum size of the first in-game object; a maximum size of the first in-game object; and/or a fixed volume of the first in-game object.

### BRIEF DESCRIPTION OF THE DRAWINGS

Embodiments and examples will now be described by way of non-limiting examples with reference to the accompanying drawings, in which:

FIG. 1 shows an overview of example method of simulating an in-game affine body;

FIG. 2 shows an overview of an example method of simulating an interaction between an in-game affine body and a further in-game object;

FIG. 3 shows a flow diagram of an example method of simulating an in-game affine body;

FIG. 4 shows a flow diagram of an example method of using a state of an in-game affine body to control an in-game texture;

FIG. 5 shows a flow diagram of an example method of using a state of an in-game affine body to control an in-game texture; and

FIG. 6 shows a schematic overview of a computer system.

### DETAILED DESCRIPTION

Non-rigid motion of in-game objects can be simulated by representing one or more in-game objects as an affine body. Such in-game objects may be represented by a set of points representing a rest shape of the object, and an affine transformation mapping the rest shape of the object to an in-game position, shape and orientation.

An affine transform is a geometric transform that preserves straight lines and parallelism. An affine transform of an N-dimensional object can be represented as a combination of a translation and a linear transform. For example, a 3D object undergoing affine transformation can be described using a 3-component translation vector, b, and a 3×3 deformation matrix, A. Each point, xᵢ, of an object in the game world can be represented in terms of its corresponding rest position, x′ᵢ, as:

xᵢ=Ax′ᵢ+b

The deformation matrix, A, is a general linear transformation (i.e. A∈GL(3, R)), and thus can represent rotations, stretches, squashes and sheer.

By contrast, a rigid body can translate and rotate, but not stretch/squash/shear. Like affine motion, 3D rigid motion can be represented as a translation vector, b, and 3×3 matrix, R. However, the contents of the matrix are more restricted than the affine case; R must be a rotation matrix (i.e. R∈SO(3))).

A core idea of affine body dynamics is to extend support for affine motion into the physics system and make use of the full range of deformations available in the affine motion representation. A body undergoing affine motion can squash, stretch and shear in three axes as well as rotate and translate. All of these motions can be accommodated in the physics system and can be made to work together with the kinds of motion that are already supported. This would allow, for instance, a stack of soft bodies to jiggle when they are poked, or a kicked football to be compressed in the direction of the kick force while expanding in the other two directions. These effects would thus be present in the physics system itself, and not just added in as a graphical effect, allowing realistic in-game interactions with such objects, and consequently improving the in-game experience for users.

The use of affine bodies to represent in-game objects also leverages existing rigid body dynamics simulators that are already in use, allowing support for simple deformations such as squash and stretch, and shearing in response to external forces and collisions. By reusing existing machinery already used for rigid body dynamics, deformable body behavior can be incorporated without the need for substantial changes to how a world is represented, or new content or systems to be created in the game. Furthermore, the representation of in-game objects as affine bodies is compatible with current collision detection methods. Collision detection is one of the most expensive parts of a physics system. Game physics engines typically rely on two types of shape representation—analytical objects like spheres & capsules, and convex hulls. Applying an affine transform to an object does not break convexity, thus it is possible to represent every affine object as a convex hull that can be transformed appropriately and then used for collision detection without having to write any new collision code.

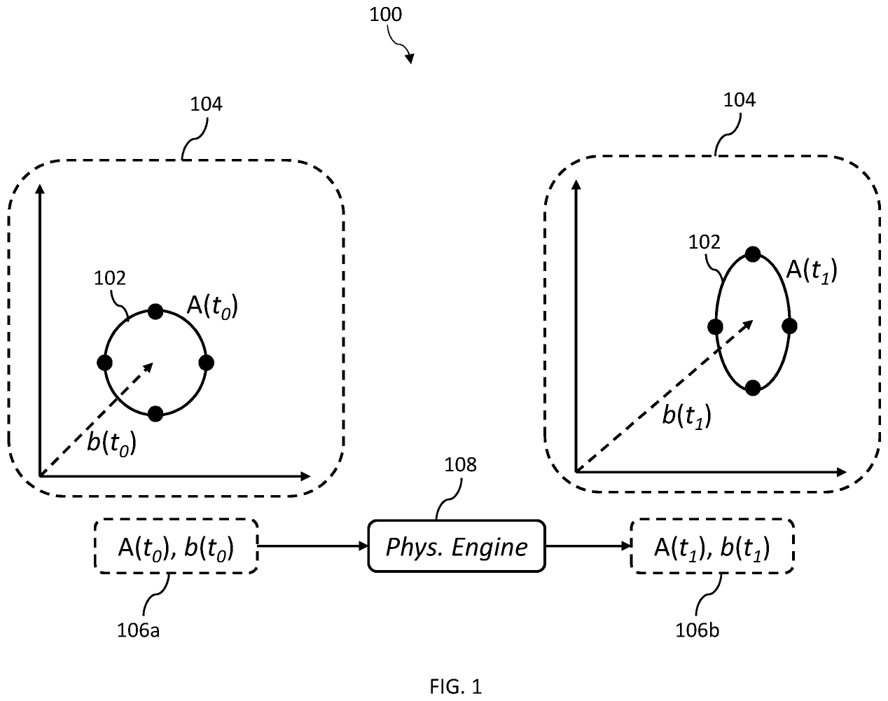

FIG. 1 shows an overview of example method 100 of simulating an in-game affine body. In the example shown, an in-game object 102 is represented as an affine body (also referred to herein as an “in-game affine body 102”), and is simulated moving through an in-game environment 104 at a plurality of time steps. Allowing for affine motion and squash/stretch of objects implies that the object has some internal elasticity. If an elastic object is squashed, then forces will be generated that push the object back to its original shape when the squashing is terminated. This means affine objects have the ability to store internal energy, which rigid bodies cannot do. Furthermore, most objects also show some degree of volume preservation—if an object preserves volume then when it is squashed in one axis it should bulge out in the other two axis. Consequently, unlike a rigid body, the in-game affine body 102 may deform under its own elasticity as it moves through the environment 104. In the example shown, the affine body is vibrating as it moves through the in-game environment 104, though it will be appreciated that the motion of the affine body may alternatively or additionally comprise other effects, such as twisting and/or rotating.

The in-game affine body 102 is represented as an affine transformation of a rest shape of the in-game object. For convenience, the in-game affine body is shown in 2D, though it will be appreciated that the method 100 may be applied in other numbers of dimensions, such as 3D.

At game time t₀, the state of the in-game object 102 is described in the environment 104 by state data 106a-b comprising a deformation matrix A(t₀) and a translation vector, b(t₀). The state data may also comprise a velocity and a deformation velocity (not shown), though these may alternatively be derived from current and/or previous values of the translation vector and deformation matrix respectively, for example via numerical differentiation.

An in-game physics engine 108 is used to simulate the physics of the in-game object 102 to determine an updated state 106b of the object the next time step, t₁. The updated state 106b comprises an updated deformation matrix A(t₁) and an updated translation vector, b(t₁). The in-game physics engine 108 then uses the updated state 106b of the in-game object 102 to continue to simulate the physic of the in-game object 102 and determine further updated states 106b of the object at following time steps, t₂, t₃, t₄, etc. This process is iterated while the object remains in the game environment 104.

Simulating the physics of the in-game object 102 may comprise determining a current (i.e. t=t0) deformation state of the object and a current deformation velocity of the object, e.g. by numerically differentiating the deformation state of the object. Derivatives of the potential energy of the object are also taken to obtain forces acting on the object 102, e.g. the potential energy of the current state 106a of the object is determined, and it's derivatives taken (either numerically or analytically)). A numerical integration may be performed by the physics engine 108 to obtain the physics state of the object at the next time step (i.e. t=t₁) from the current physics state of the object using the obtained forces. This process is iterated at a plurality of time steps to simulate the evolution of the physics state of the object.

Behavior related to internal elastic-plasticity of in-game affine bodies 102 may be represented by storing an affine deformation tensor per deformable body, and allowing users (e.g. game designers) to set object parameters that define the physical properties of the in-game affine bodies 102. Such properties may include one or more of: stiffness; volume preservation, damping and/or plasticity behavior of each object. In some implementations, material pre-sets are used to allow users to select an appropriate set of parameters all together by choosing from a menu of pre-defined materials. For example, the list may include material pre-sets for rubber, steel, aluminium, jello etc.

In the limit of a body being very severely compressed, it may in fact become flat or even inverted. This is equivalent to an affine transform with a determinant of 0 (flat case) or negative (inverted case). In some embodiments, this can be prevented by including a hard constraint into the internal deformation simulation that clamps the minimum size of the object in each axis. This avoids potential simulation problems resulting from the ability to non-physically invert objects.

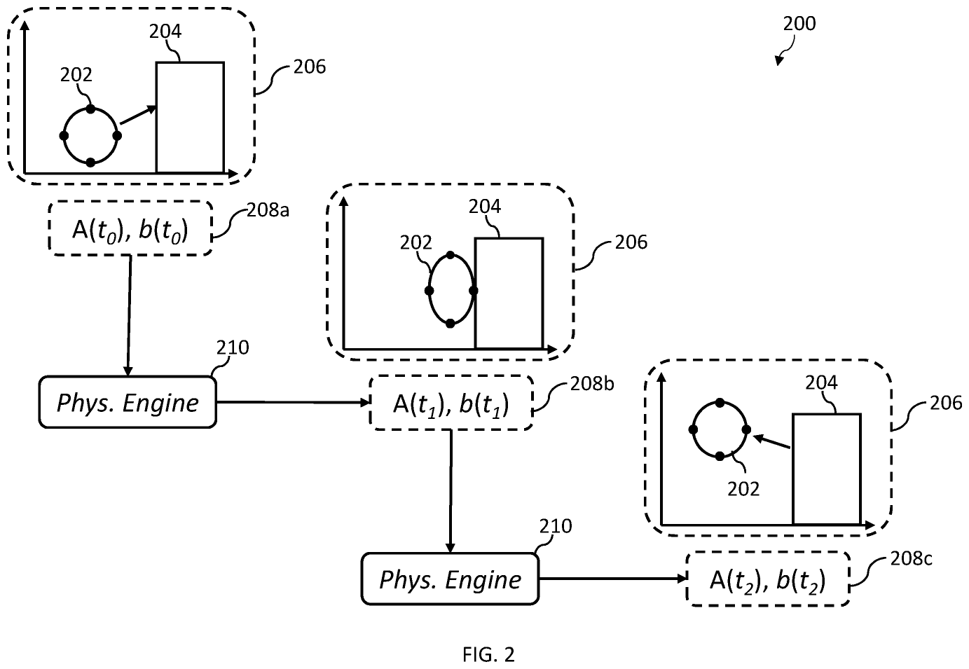

FIG. 2 shows an overview of an example method 200 of simulating a collision between two in-game objects.

In the example shown, a first in-game affine body 202 is interacting with a second body 204 in the game environment 206, though it will be appreciated that in general a plurality of bodies may be interacting. The second body may be a rigid body or a further affine body; in the example shown the second body 204 is a fixed rigid body. In some embodiments, a collision between two affine bodies can be reduced to a collision between an affine body and a rigid body by a suitably defined transformation.

To simulate the interaction, a physics engine 210 is used to determine the physics state 208a-b of the objects in the game environment 206 at each time step (t₀, t₁, t₂, etc.) of the simulation. The physics state 208 comprises the deformation matrix, A, and translation vector, b, of the first body 202 and data representing the state of the second body (e.g. its position and rotation/deformation matrix). The physics state 208 is determined by solving equations of motion of the objects 202, 204 in the game environment 206 subject to one or more constraints, starting from the current physics state of the objects 202, 204.

The example shown, a spherical body, such as a ball, is bouncing off a rigid body, such as a wall. The initial in-game physics state 208a comprises the state of the affine body 202 given by the deformation matrix A(t₀) and translation vector b(t₀), describing a spherical body moving from left to right. The second body 204 is a fixed rigid body. The physics engine 210 determines updates to the physics state 208a by simulating the physics of the bodies in the game environment 206, starting from the current physics state 208a. The updated physics state 208b comprises the state of the affine body 202 given by the deformation matrix A(t₁) and translation vector b(t₁), describing the affine body 202 deforming as it contacts the second body 204. Such deformations cannot be accounted for in rigid body dynamics. The physics engine 210 determines updates to the updated state 208b by simulating the physics of the bodies in the game environment 206, starting from the updated physics state 208b. This further updated physics state 208c comprises the state of the affine body 202 given by the deformation matrix A(t₂) and translation vector b(t₂), describing the affine body 202 moving from right to left.

The method 200 may use a compliant constraint formalism (also referred to a “compliant constraint method”) to simulate the interaction between the first body 202 and the second body 204. An example of the compliant constraint formalism is described in “Interactive Simulation of Elastic deformable Bodies” (M. Servin et al., In Proceedings of SIGRAD Conference, pages 22-32, 2006.), the contents of which are incorporated herein by reference in their entirety. A compliant constraint method simulates the physics of the in-game objects 202, 204 by solving their equations of motion under one or more constraints. However, the constraint equations are not solved exactly; instead, they are relaxed based on the stiffness of the affine body.

As an example, the equations of motion of an affine body may be given by the definition of its velocity, v, and Newton's second law, i.e.:

v=\dot{x}

m\dot{v}=F+F_{c}

where x is a vector of the positions points in the object, m is the mass, F is the sum of external forces, Fₑₓₜ, and internal forces, Fᵢₙₜ, acting on the object, and F_{c} is the forces acting on the object due to constraints. The constraints on the object can be formulated as a set of equations of the form:

ϕ(x)=0

The constraints may, for example, include a collision constraint between the first and second body. For example, the constraints may comprise a constraint that the objects do not overlap, i.e. a non-penetration constraint. The constraints may comprise a volume preservation constraint, such as fixing the volume of the first body or limiting the variation of the volume of the first body (e.g. setting a minimum and/or maximum volume for the body, and/or a minimum and/or maximum length in each dimension).

Many other examples of constraints are possible, including, but not limited to: constraints on the internal energy of the affine body 202; constraining objects to remain in contact with one or more surfaces; maximum/minimum velocities of objects; and/or momentum conservation constraints.

Instead of solving these constraints exactly, the constraints are relaxed in dependence on a stiffness of the affine body. Consequently, the constraints are reformulated to be of the form:

αλ(x, t)=−ϕ(x, t)

where α is the inverse of a stiffness matrix and λ is an artificial variable, λ=−α⁻¹ϕ. Under such a reformulation, the constraint forces, F_{c} are given by

F_{c}=J^{T}λ

where J is the Jacobian matrix of ϕ with respect to x. In some embodiments, a dissipative term may also be included in the constraints in order to provide numerical stability. This term may, for example, be of the form −β\dot{ϕ} for some positive constant β.

The system of equations (i.e. the equations of motion plus the relaxed constraints) may be solved using numerical integration techniques to calculate the positions of the points in the in-game body 202 (and the other bodies in the environment) at the next time step of the physics simulation.

As an illustrative example, the equations of motion and constraints may “time-stepped” by numerically integrating from a current time, t, to the next time step, t+Δt, giving:

$${x}_{n + 1} = {x}_{n} + Δ t {v}_{n + 1}$$

$$[ \begin{matrix}M & - J \\ J & γ Δ {t}^{- 2} α\end{matrix} ] [ \begin{matrix}{v}_{n + 1} \\ Δ t \tilde{λ}\end{matrix} ] = [ \begin{matrix}M {v}_{n} + Δ t F \\ - γ Δ {t}^{- 1} ϕ\end{matrix} ]$$

where \tilde{λ} is the time average of λ over the time step and γ=(1/2+Δtβ)⁻¹. This system of equations may be solved using any method known in the art, for example a sparse matrix solver.

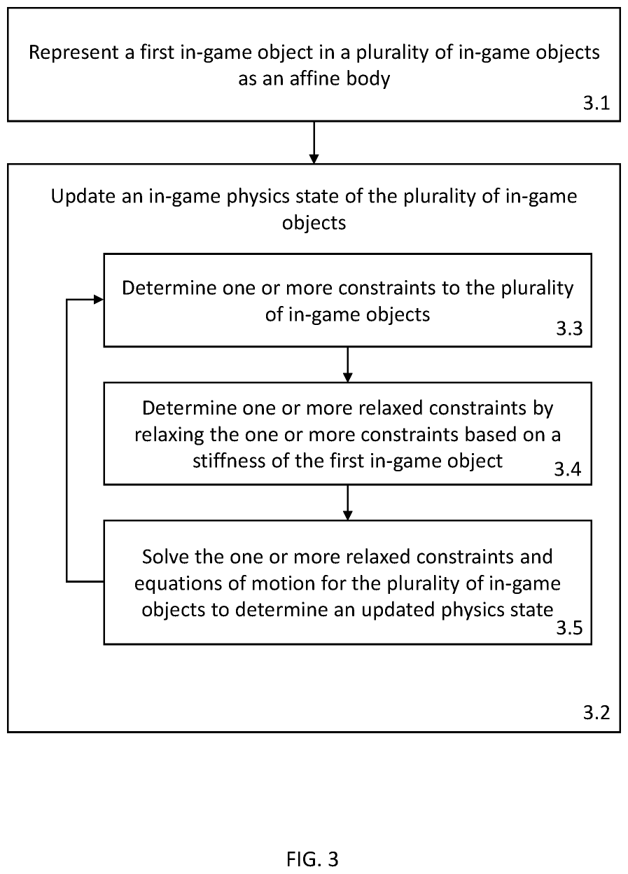

FIG. 3 shows a flow diagram of an example method of simulating the physics of an in-game object. The method may be performed by one or more processors of a computer system.

At operation 3.1, a first in-game object in a plurality of in-game objects is represented as an affine body. In general, a game environment will contain a plurality of in-game objects. It may not be necessary to represent every object in the environment as an affine body; for example, objects that do not deform may be represented as rigid bodies.

Representing an object as an affine body comprises representing said object as an affine transformation of a respective rest object. The affine transformation comprises a deformation matrix, A, and a translation vector, b. Representing the object as an affine body may further comprise associating a stiffness with the object, e.g. assigning a stiffness matrix, α, to the object.

At operation 3.2, an in-game physics state of the plurality of in-game objects is updated. The in-game physics state includes a state of the first in-game object, which comprises the current value of the deformation matrix and translation vector representing the object. The state of the first in-game object may further comprise one or more of: a kinetic energy; linear momentum; angular momentum; a velocity; and/or an internal energy The physics state may further comprise the state of the other in-game objects in the environment, such as their respective deformation/rotation matrices, linear/angular momentum,

The physics updates are determined using a compliant constraint formalism. Operations 3.3 to 3.5 are iterated to determine the updated physics state.

At operation 3.3, one or more constraints are applied to the plurality of in-game objects. The constraints may be represented as a condition that that one or more functions of the physics state of the system are each equal to zero, e.g. ϕ(x, t)=0.

The constraints may comprise one or more collision constraints between the first in-game object and one or more further in-game objects, e.g. a constraint that the in-game objects do not overlap, such as a constraint on the minimum distance between the centres of the two objects. The constraints may comprise an internal energy constraint of the first in-game object. The constraints may comprise a volume preservation constraint. The constraints may comprise a constraint limiting the motion of the object, e.g. constraining the object to remain in contact with a given surface or other object. In some embodiments, the constraints may depend of the current state of the first body, e.g. its deformation matrix. Many other examples will be familiar to the person skilled in the art.

At operation 3.4, a relaxed set of constraints is obtained by relaxing the one or more constraints based at least in part on a stiffness of the first in-game object.

Relaxing the constraints may comprise replacing the constraint equation with an equation of the form −ϕ(x, t)=αλ, where a is the inverse of a stiffness matrix and λ is an arbitrary variable. Alternatively, a convergence threshold for the constraints may be set based on the stiffness of the first in-game object, i.e. a threshold error to which the constraints should be solved to within. The convergence threshold may be proportional to the inverse of the stiffness matrix, α, such that the threshold approaches zero as the stiffness tends to infinity.

In some implementations, a dissipative term of the form −β\dot{ϕ}may also be introduced to the constraints to improve numerical stability.

At operation 3.5, the equations of motion and one or more relaxed constraints are solved to determine an updated in-game physics state. The set of equations may be solved using any method known in the art. For example, a numerical integration scheme may be applied to the equations to determine the physics state of the first in-game object at the next time step, as described above in relation to FIG. 2.

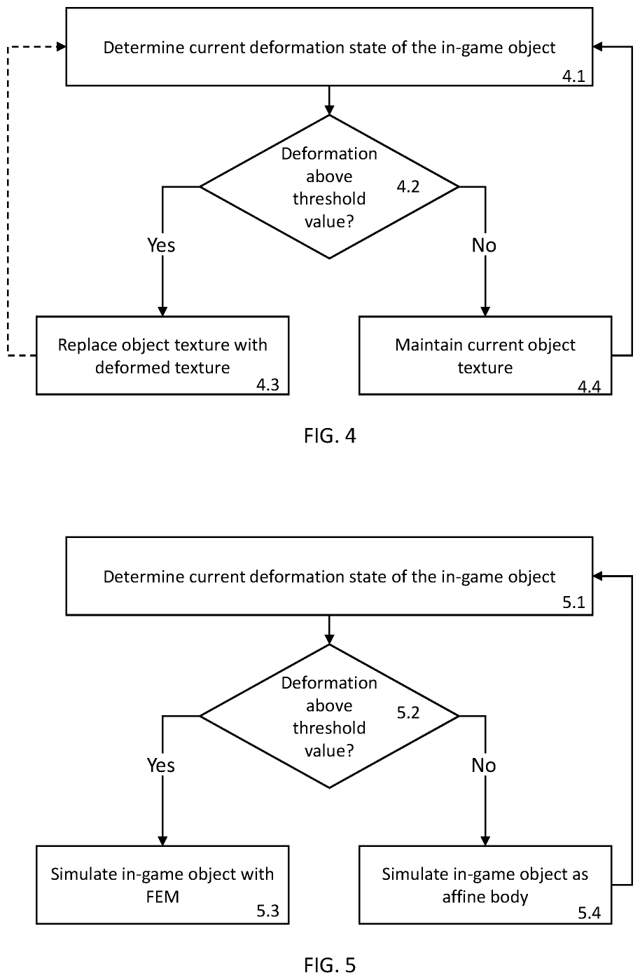

The affine body representation of in-game objects can additionally be used to control other aspects of gameplay in a computer game. FIG. 4 shows a flowchart of an example method of updating an animation texture of an in-game affine body based on a deformation state of the body. The method may be performed by one or more processors. The deformation matrix of the affine body is used to determine a transition between textures of the object used to render the object in-game, and/or when to consider an in-game object destroyed.

For example, the in-game object may initially be in a “pristine” condition, represented by a “clean” texture. However, if the object is deformed beyond a threshold, the initial texture may be replaced with a “deformed” texture showing, for example, surface damage to the object. Further deformations beyond additional thresholds may cause the texture of the in-game object to be replaced again with more deformed versions of the texture, or even removed from the game environment when the when the deformation is sufficiently high to indicate that the object should be destroyed.

FIG. 4 shows a flow diagram of an example method of controlling the graphical representation of an in-game object. At operation 4.1, the current deformation state of the object determined. The deformation state may be determined from the deformation matrix, A, of the affine body, for example by calculating a strain tensor from the deformation matrix of the in-game object. Alternatively, the deformation state may comprise the deformation along each of three independent axes of the object and/or the determinant of the deformation matrix.

At operation 4.2, the deformation state is compared to one or more threshold values. The one or more threshold values define one or more sets of conditions for switching the texture of the object, each set of conditions comprising one or more threshold values.

The threshold values may comprise an upper threshold value and/or a lower threshold value. The one or more threshold values may comprise threshold strain values of the strain tensor. Alternatively, the threshold values my comprise threshold deformation and/or threshold value of the determinant/eigenvalues of the deformation matrix.

The threshold values may depend on material properties assigned to the affine body. For example, the threshold values may depend on the stiffness, plasticity and/or identity of the affine body.

If one or more of the sets of conditions defined by the threshold values is satisfied, the method proceeds to operation 4.3. For example, if values of the strain in the strain tensor exceed respective threshold values, then the method proceeds to operation 4.3. If the conditions defined by the threshold values are not satisfied, the method proceeds to operation 4.4.

At operation 4.3, if one or more of the sets of conditions defined by the threshold values is satisfied, the texture used to represent the object in animations is replaced with a deformed texture. Subsequently, the object is represented in-game using the deformed texture rather than its initial texture. The deformed texture may represent a damaged, crumpled and/or dented surface texture for the object. In some embodiments, the method then returns to operation 4.1 to determine whether to replace the updated surface texture with a further texture (e.g. a more damaged texture) as the object deformation state changes.

In some embodiments, one or more of the thresholds may relate to a destruction condition for the in-game object. If any of the conditions associated with these “destruction thresholds” are met, then the in-game object may be removed from the game environment. The removal of the object from the environment may be accompanied by an associated destruction animation, e.g. an explosion.

At operation 4.4, if none of the sets of conditions defined by the threshold values is satisfied, then the current texture of the object is maintained, and the method returns to operation 4.1 and repeats with the deformation state of the object for the next time step in the physics simulation.

It is also possible to use the affine deformation matrix as a signal to change the representation of the object. For instance, an object that is stretched a long way from its equilibrium could be swapped to an equivalent object simulated with FEM, which would allow it to deform further with a more accurate representation that would allow for even further rich deformation beyond the affine limit. An example of a flowchart of such a method is shown in FIG. 5.

Operations 5.1 and 5.2 of FIG. 5 proceed in the same manner as those of operations 4.1 and 4.2 of FIG. 4; a current deformation state of the in-game object is determined from the current deformation matrix, and compared to one or more sets of threshold values that defined one or more conditions. Here, the threshold conditions define whether the deformation state can still be accurately accommodated within the affine boy framework, or whether a more computationally expensive method, such as the Finite Element Method (FEM) is required. The one or more of the conditions is satisfied, the method proceeds to operation 5.3, otherwise it proceeds to operation 5.4

At operation 5.3, if one or more of the conditions is satisfied, then the representation of the in-game object is switched to a higher order representation. The higher order representation is in general a finer, more detailed representation of the in-game object, e.g. a finite element representation or a material point representation, that represents the object using a e.g. a mesh. The physics of the in-game object is then simulated using a simulated method associated with the refined representation, e.g. the Finite Element Method (FEM) or Material Point Method (MPM).

The representation of the object may be transitioned back to the affine representation once the object deformation satisfies one or more criteria. For example, when the state of the object as determined by the simulated method associated with the refined representation indicates that the deformation of the object is below a threshold value, the representation of the object may be switched back to an affine representation, and the object subsequently simulated as an affine body again. The method then returns to operation 5.1.

At operation 5.4, if none of the sets of conditions defined by the threshold values is satisfied, then the in-game object is simulated as an affine body, as described above in relation to FIGS. 1-3. The method then to operation 5.1 and repeats with the deformation state of the object for the next time step in the physics simulation.

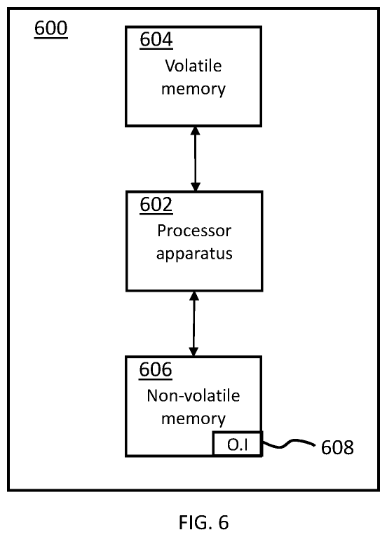

FIG. 6 shows a schematic example of a system/apparatus 600 for performing any of the methods described herein. The system/apparatus shown is an example of a computing device. It will be appreciated by the skilled person that other types of computing devices/systems may alternatively be used to implement the methods described herein, such as a distributed computing system.

The apparatus (or system) 600 comprises one or more processors 602. The one or more processors control operation of other components of the system/apparatus 600. The one or more processors 602 may, for example, comprise a general purpose processor. The one or more processors 602 may be a single core device or a multiple core device. The one or more processors 602 may comprise a Central Processing Unit (CPU) or a graphical processing unit (GPU). Alternatively, the one or more processors 602 may comprise specialized processing hardware, for instance a RISC processor or programmable hardware with embedded firmware. Multiple processors may be included.

The system/apparatus comprises a working or volatile memory 604. The one or more processors may access the volatile memory 604 in order to process data and may control the storage of data in memory. The volatile memory 604 may comprise RAM of any type, for example Static RAM (SRAM), Dynamic RAM (DRAM), or it may comprise Flash memory, such as an SD-Card.

The system/apparatus comprises a non-volatile memory 606. The non-volatile memory 606 stores a set of operation instructions 608 for controlling the operation of the processors 602 in the form of computer readable instructions. The non-volatile memory 606 may be a memory of any kind such as a Read Only Memory (ROM), a Flash memory or a magnetic drive memory.

The one or more processors 602 are configured to execute operating instructions 608 to cause the system/apparatus to perform any of the methods described herein. The operating instructions 608 may comprise code (i.e. drivers) relating to the hardware components of the system/apparatus 600, as well as code relating to the basic operation of the system/apparatus 600. Generally speaking, the one or more processors 602 execute one or more instructions of the operating instructions 608, which are stored permanently or semi-permanently in the non-volatile memory 606, using the volatile memory 604 to store temporarily data generated during execution of said operating instructions 608.

Implementations of the methods described herein may be realised as in digital electronic circuitry, integrated circuitry, specially designed ASICs (application specific integrated circuits), computer hardware, firmware, software, and/or combinations thereof. These may include computer program products (such as software stored on e.g. magnetic discs, optical disks, memory, Programmable Logic Devices) comprising computer readable instructions that, when executed by a computer, such as that described in relation to FIG. 6, cause the computer to perform one or more of the methods described herein.

Any system feature as described herein may also be provided as a method feature, and vice versa. As used herein, means plus function features may be expressed alternatively in terms of their corresponding structure. In particular, method aspects may be applied to system aspects, and vice versa.

Furthermore, any, some and/or all features in one aspect can be applied to any, some and/or all features in any other aspect, in any appropriate combination. It should also be appreciated that particular combinations of the various features described and defined in any aspects of the invention can be implemented and/or supplied and/or used independently.

Although several embodiments have been shown and described, it would be appreciated by those skilled in the art that changes may be made in these embodiments without departing from the principles of this disclosure, the scope of which is defined in the claims

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and are believed to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

1. A computer implemented method comprising:
representing a first in-game object in a plurality of in-game objects using an affine body representation, wherein the affine body representation comprises a translation vector and a deformation matrix; and
updating an in-game physics state of the plurality of in-game objects, the in game physics state comprising a current translation vector and a current deformation matrix of the first in-game object, the updating comprising:
determining one or more constraints to the plurality of in-game objects;
determining one or more relaxed constraints by relaxing the one or more constraints based on a stiffness of the first in-game object; and
determining an updated in-game physics state of the first in-game object, comprising solving the one or more relaxed constraints and equations of motion for the plurality of in-game objects.

2. The method of claim 1, wherein updating the in-game physics state of the plurality of in-game objects comprises simulating a collision between the first in-game object and a second object in the plurality of in-game objects, and wherein the one or more constraints comprises one or more collision constraints.

3. The method of claim 2, wherein the second object in the plurality of in-game objects comprises an in-game object represented as a rigid body.

4. The method of claim 2, wherein the second object in the plurality of in-game objects comprises an in-game object represented as an affine body.

5. The method of claim 1, wherein the method further comprises:
determining whether a current deformation matrix of the first in-game object represents a deformation above a threshold deformation; and
in response to a positive determination, replacing a current in-game graphical texture of the first in-game object with deformed texture.

6. The method of claim 1, wherein the method further comprises:
determining whether a current deformation matrix of the first in-game object represents a deformation above a threshold deformation; and
in response to a positive determination, replacing the affine representation of the object with a higher order representation.

7. The method of claim 1, wherein the one or more constraints further comprises one or more of: a minimum size of the first in-game object; a maximum size of the first in-game object; and/or a fixed volume of the first in-game object.

8. A non-transitory computer readable medium comprising computer readable instructions that, when executed by a computer, cause the computer to perform a method comprising:
representing a first in-game object in a plurality of in-game objects using an affine body representation, wherein the affine body representation comprises a translation vector and a deformation matrix; and
updating an in-game physics state of the plurality of in-game objects, the in-game physics state comprising a current translation vector and a current deformation matrix of the first in-game object, the updating comprising:
determining one or more constraints to the plurality of in-game objects;
determining one or more relaxed constraints by relaxing the one or more constraints based on a stiffness of the first in-game object; and
determining an updated in-game physics state of the first in-game object, comprising solving the one or more relaxed constraints and equations of motion for the plurality of in-game objects.

9. The non-transitory computer readable medium of claim 8, wherein updating the in-game physics state of the plurality of in-game objects comprises simulating a collision between the first in-game object and a second object in the plurality of in-game objects, and wherein the one or more constraints comprises one or more collision constraints.

10. The non-transitory computer readable medium of claim 9, wherein the second object in the plurality of in-game objects comprises an in-game object represented as a rigid body.

11. The non-transitory computer readable medium of claim 9, wherein the second object in the plurality of in-game objects comprises an in-game object represented as an affine body.

12. The non-transitory computer readable medium of claim 8, wherein the method further comprises:
determining whether a current deformation matrix of the first in-game object represents a deformation above a threshold deformation; and
in response to a positive determination, replacing a current in-game graphical texture of the first in-game object with deformed texture.

13. The non-transitory computer readable medium of claim 8, wherein the method further comprises:
determining whether a current deformation matrix of the first in-game object represents a deformation above a threshold deformation; and
in response to a positive determination, replacing the affine representation of the object with a higher order representation.

14. The non-transitory computer readable medium of claim 8, wherein the one or more constraints further comprises one or more of: an minimum size of the first in-game object; a maximum size of the first in-game object; and/or a fixed volume of the first in-game object.

15. A system comprising one or more processors and a memory, the memory storing computer readable instructions that, when executed by the one or more processors, causes the system to perform a method comprising:
representing a first in-game object in a plurality of in-game objects using an affine body representation, wherein the affine body representation comprises a translation vector and a deformation matrix; and
updating an in-game physics state of the plurality of in-game objects, the in game physics state comprising a current translation vector and a current deformation matrix of the first in-game object, the updating comprising:
determining one or more constraints to the plurality of in-game objects;
determining one or more relaxed constraints by relaxing the one or more constraints based on a stiffness of the first in-game object; and
determining an updated in-game physics state of the first in-game object, comprising solving the one or more relaxed constraints and equations of motion for the plurality of in-game objects.

16. The system of claim 15, wherein updating the in-game physics state of the plurality of in-game objects comprises simulating a collision between the first in-game object and a second object in the plurality of in-game objects, and wherein the one or more constraints comprises one or more collision constraints.

17. The system of claim 16, wherein the second object in the plurality of in-game objects comprises an in-game object represented as a rigid body.

18. The system of claim 15, wherein the method further comprises:
determining whether a current deformation matrix of the first in-game object represents a deformation above a threshold deformation; and
in response to a positive determination, replacing a current in-game graphical texture of the first in-game object with deformed texture.

19. The system of claim 15, wherein the method further comprises:
determining whether a current deformation matrix of the first in-game object represents a deformation above a threshold deformation; and
in response to a positive determination, replacing the affine representation of the object with a higher order representation.

20. The system of claim 15, wherein the one or more constraints further comprises one or more of: a minimum size of the first in-game object; a maximum size of the first in-game object; and/or a fixed volume of the first in-game object.
